(19) United States
(12) Patent Application Publication
(10) Pub. No.: US 2013/0314019 A1
(43) Pub. Date: Nov. 28, 2013

(54) HIGH SPEED OPENER FOR GARAGE DOORS UTILIZING A COUNTERBALANCING SPRING

(71) Applicant: Corey Glen Wilmes, Henderson, MN (US)

(72) Inventor: Corey Glen Wilmes, Henderson, MN (US)

(21) Appl. No.: 13/834,050

(22) Filed: Mar. 15, 2013

Related U.S. Application Data
(60) Provisional application No. 61/651,372, filed on May 24, 2012.

(51) Int. Cl. H02P 23/00

(52) U.S. Cl. CPC H02P 23/0063
USPC 318/470

(57) ABSTRACT

A high speed garage door system and related methods of operation with a garage door working in conjunction with a counterbalancing spring. The high speed garage door system can include an operator configured as a high speed jackshaft opener or alternatively, with a high speed trolley opener. The operator can includes a three phase brake motor that receives a simulated three phase signal from a variable frequency drive. Using a series of shafts and a torque limiter, the motor can quickly accelerate and decelerate such that the garage door can open and close at an average speed exceeding about 2 feet per second. A system controller communicates with an encoder mounted on an output shaft of the motor such that the position of the garage door remains known to the system controller even in the event of slippage caused by the torque limiter.

### RELATED APPLICATION

The present application claims the benefit of U.S. Provisional Application No. 61/651,372 filed May 24, 2012, and entitled “HIGH SPEED OPENER FOR GARAGE DOORS UTILIZING A COUNTERBALANCING SPRING, which is incorporated herein in its entirety by reference.

### FIELD OF THE INVENTION

The present invention is directed to garage door openers. More specifically, the present invention is directed to a high speed garage door opener for garage doors heavy enough to require a counterbalancing spring for operation.

### BACKGROUND OF THE INVENTION

Operators for opening and closing garage doors are used extensively throughout industry and residential buildings. Most residential door opening systems tend to be small and lightweight and are not designed for rapid operation. Typically, doors used on residences are engineered for the lowest cost while maintaining safety and reliability at a design rate of about one foot per second linear speed. These operators often rely upon simple position sensors and single-speed drives to keep costs low. Conventional garage door openers are usually designed to lift moderately heavy doors such as insulated or wood doors using a motor and transmission at a single speed. Many of these units use single-phase AC electric motors which use various schemes to achieve enough starting torque such as split capacitor or permanent split capacitor. Their limited amount of starting torque requires enough mechanical gear reduction to start or stop the overhead door which results in their low speed.

The transmissions typically used in overhead garage doors are arranged from series of sprockets connected via chain links. Worm gears are also used to create suitable reductions to target 1 foot per second speeds. Chain drives are easy to back drive and can be problematic when trying to hold a door open part way when power is removed. Work gears are used as they are difficult to back drive and are better able to hold position when power is interrupted. If power is interrupted and the door is desired to be moved, the door must be disengaged from the operator system using a latch or clutch. Also, mechanical rotary torque limiters are often coupled to the transmission to divorce high torques from damaging the transmission components such as when hitting an obstruction or lifting a door frozen to the ground.

While there are many designs and types of door operators each achieving their intended function, they all generally travel at approximately 1 foot per second linear speed. In northern climates, many businesses desire to heat their shop, bay, factory, hanger, garage, or utility buildings. These heated spaces use considerable energy to stay warm and loose much of their energy when their large overhead doors are opened. Consider that a when a typical car dealership opens its overhead door to let in a customer for vehicle service, that a door traveling 14′ vertically and closed immediately take 20 seconds while a 100 sq. foot opening is created. The loss in heated air is expensive, and the rush of below zero air chills the mechanics and freezes water on the floor. Similar but opposite results are found in warm weather or tropical locations that utilize air conditioning to cool garages and service areas. In order to deal with the large openings that are created when opening and closing overhead doors, lightweight roll up or coiling-style door are frequently utilized and operated at much higher speeds than conventional garage doors as these roll up doors tend to be very lightweight and can be fabricated from materials such as, for example, cloth or polymeric sheets. Unfortunately, lightweight roll up doors tend to have a very low insulation value such that when a roll up door is closed, heating and cooling costs are elevated when compared to conventional insulated garage doors.

As such, it would be desirable to have a door that can operate at high-speeds to limit the time at which openings are created during opening and closing while still having significant insulating properties when closed.

### SUMMARY OF THE INVENTION

Generally, a representative garage door system of the present invention can comprise a garage door, such as, for example a sectional or insulated panel style door or roll up steel door, that is operably connected to a high speed operator and works in conjunction with a counterbalancing spring. The high speed operator can be used with a high speed jackshaft opener or alternatively, with a high speed trolley opener. Generally, the high speed operator includes a three phase brake motor that receives a simulated three phase signal from a variable frequency drive. Using a series of shafts and a torque limiter, the motor can quickly accelerate and decelerate such that the panel-style garage door can approach a speed of at least 2 feet per second and up to about 5 feet per second based upon installation variables. A system controller communicates with an encoder mounted on an intermediate shaft such that the position of the panel door remains known to the system controller even in the event of slippage caused by the torque limiter.

In one aspect, the present invention is directed to high speed operators for garage doors that require the use of counter balancing springs for proper operation as described herein.

In another aspect, the present invention is directed to garage door openers working in conjunction with counterbalancing springs as described herein.

In yet another aspect, the present invention is directed to high speed methods for opening garage doors that utilize counterbalancing springs as described herein.

In another aspect, the present invention is directed to a high speed operator for opening sectional and insulated garage doors at speeds exceeding 2 feet per second.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a perspective view of a garage door opener system according to an embodiment of the present invention.

FIG. 2 is a perspective view of a garage door opener system according to an embodiment of the present invention.

FIG. 3 is a bottom perspective view of a high speed door operator for use with the garage door opener system of FIG. 2.

FIG. 4 is a side perspective view of a high speed door operator for use with the garage door opener system of FIG. 1.

FIG. 5 is a front view of the high speed door operator of FIG. 4.

FIG. 6 is a front view of the high speed door operator of FIG. 4 with a front cover removed.

FIG. 7 is bottom, perspective view of the high speed door operator of FIG. 3.

FIG. 8 is a front view of a control panel according to an embodiment of the present invention.

FIG. 9 is a front view of the control panel of FIG. 8 with a front control cover removed.

FIG. 10 is a schematic illustration of a garage door opener control system according to an embodiment of the present invention.

FIG. 11 is a frequency timing diagram for a garage door opening profile according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

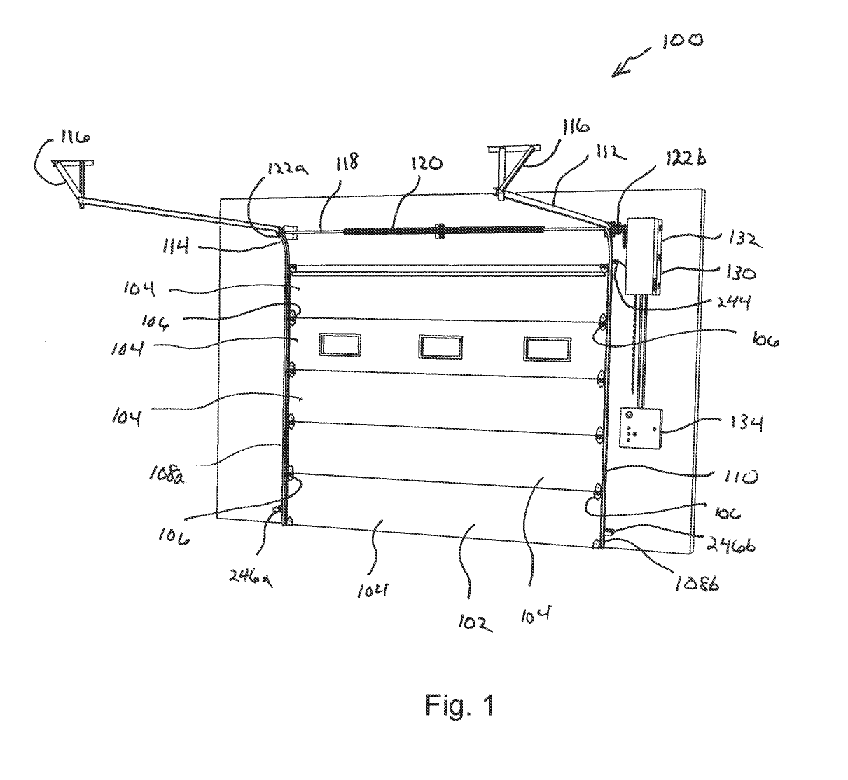

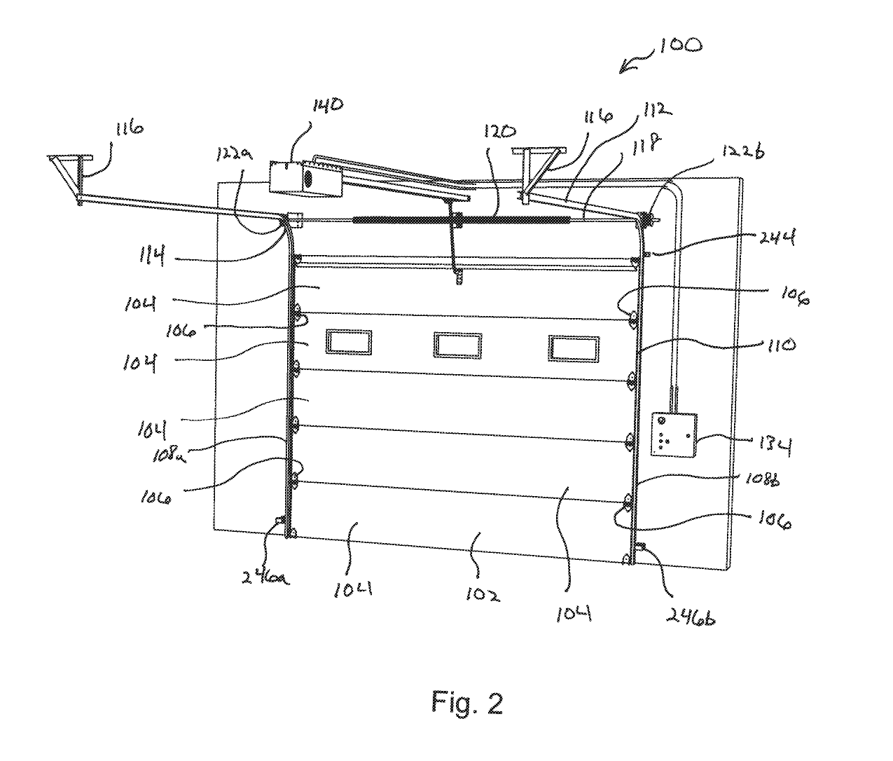

As illustrated in FIGS. 1 and 2, a garage door assembly 100 for use with operators of the present invention generally comprises a door 102. As illustrated, door 102 comprises a sectional or panel-style garage door formed of a plurality of individual panels 104. Alternatively, door 102 can comprise an insulated roll up door made of individually connected slats that can have a metallic outer shell made of metals such as aluminum or steel. Generally, door 102 can comprise any suitable door design that utilizes a design to provide for an increased insulation value. Generally, suitable doors 102 will require the use of a counterbalancing spring due to the increased weight necessitated in constructing an insulated door. Generally, individual panels 104 are bolted and held together using suitable hinges and brackets. Door 102 includes a plurality of door wheels 106 that reside within a pair of door tracks 108a, 108b. Each of door tracks 108a, 108b includes a vertical track section 110 and a horizontal track section 112 being connected by an arcuate track section 114. Vertical track sections 110 are generally attached on left and right sides of a garage opening while the horizontal track sections 112 are suspended from a ceiling with track hangers 116. Mounted between the tracks 108a, 108b and positioned above the garage opening is a torsion shaft 118 including one or more wound torsion or counter balancing springs 120. Torsion shaft 118 generally includes left and right cable drums 122a, 122b around which cables are wound and unwound. These cables generally attach on each side of a lower portion of the panel door 108 and allow rotation of the torsion shaft 118 to lift/lower the door 102 as assisted by the counter balancing springs 120.

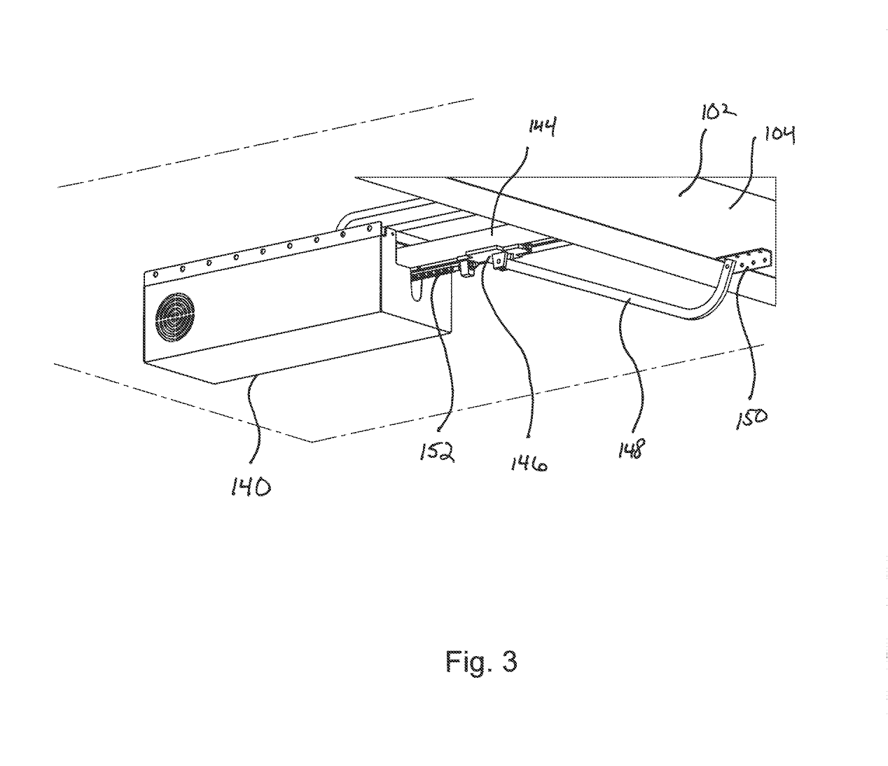

Referring specifically to FIG. 1, garage door assembly 100 can be selectively opened and closed with a high speed jackshaft opener 130 according to an embodiment of the present invention. High speed jackshaft opener 130 generally comprises a high speed operator 132 mounted alongside a garage opening and in direct connection with the torsion shaft 118 and a control panel 134. Alternatively, garage door assembly 100 can be selectively opened and closed with a high speed trolley opener 140 as illustrated in FIGS. 2 and 3. High speed trolley operator 140 generally comprises a high speed operator 142 that is mounted between the horizontal track sections 112 of door tracks 108a, 108b and control panel 134 positioned alongside the garage opening. High speed operator 142 generally couples to the door 102 using a trolley track 144, a movable trolley member 146, a connecting arm 148 and door bracket 150 such that the movable trolley member 146 is operably coupled with the uppermost panel 104. As opposed to the direct coupling of the high speed operator 132 to the torsion shaft 118, high speed operator 142 generally drives the movable trolley member 146 along the trolley track 144 via a belt, screw or chain drive 152, whereby the door 102 is lifted and/or lowered. While the connection methods to the door 102 differ for high speed operator 132 and high speed operator 142, it will be understood that many of the various control methods and components are similar if not identical as will be subsequently described.

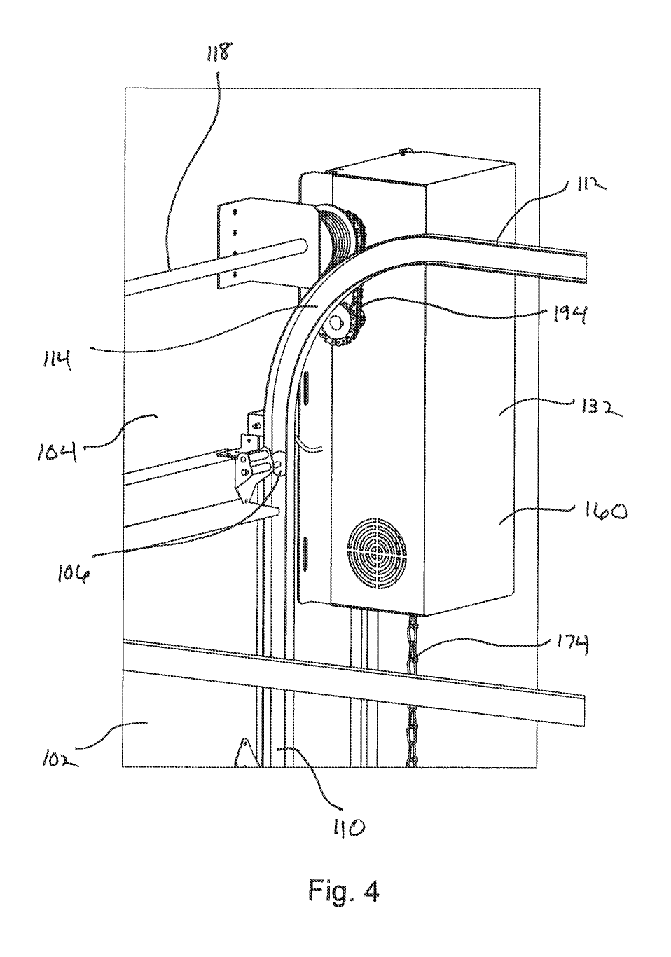

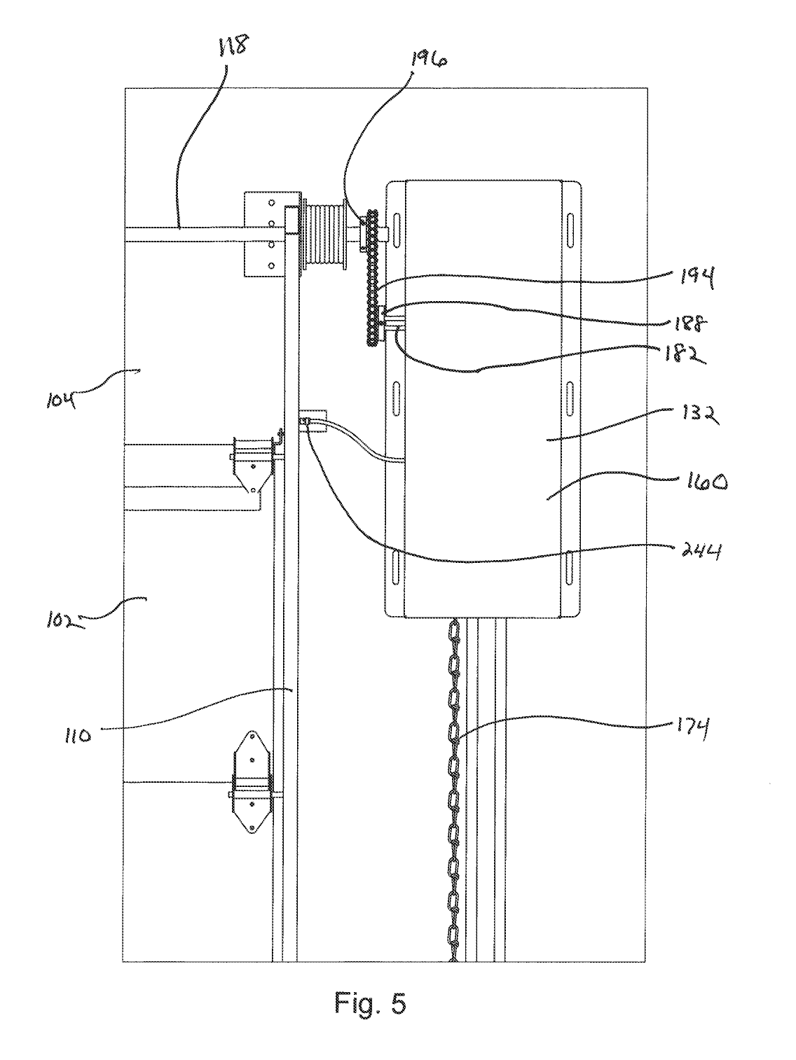

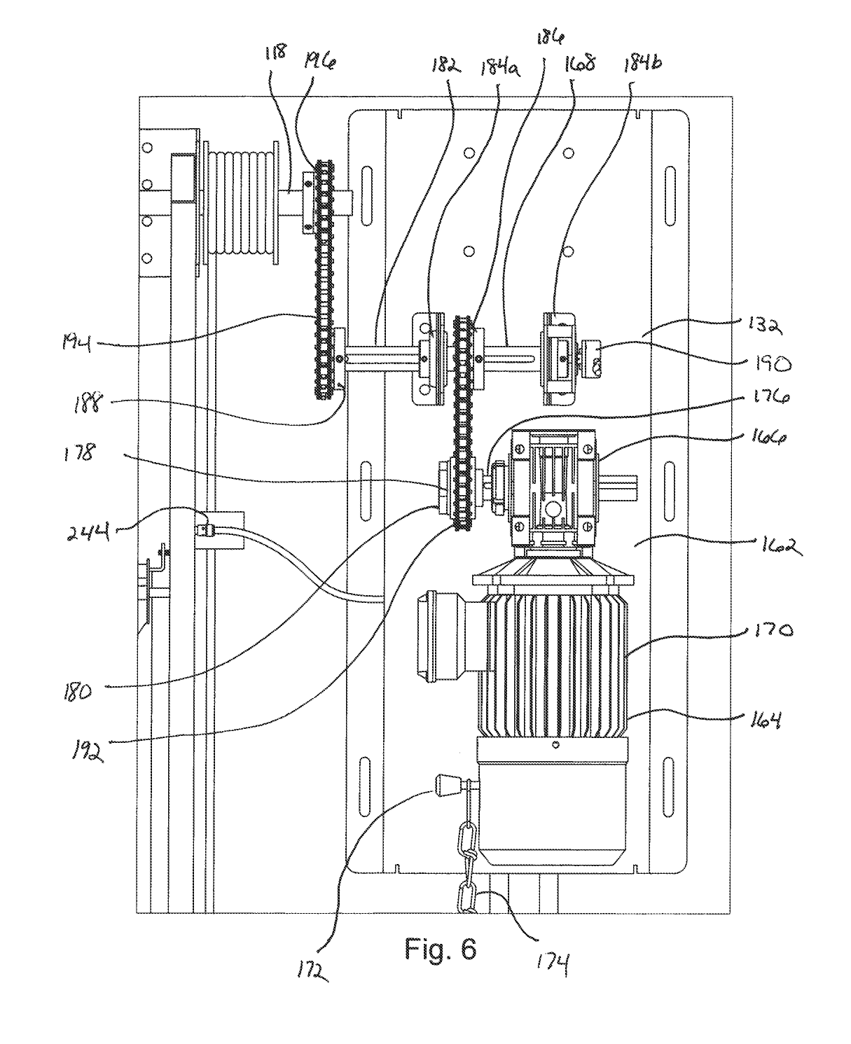

Referring now to FIGS. 4, 5 and 6, high speed operator 132 generally comprises a housing cover 160 and a mounting panel 162. Attached to the mounting panel 162 is a motor assembly 164, a gear box 166 and an intermediate shaft assembly 168. Motor assembly 164 generally includes a solenoid operated brake motor 170 having a spring clutch arrangement. Brake motor 170 can include a brake lever 172 and a corresponding brake release chain 174. Brake motor 170 is preferably a three phase motor. Gear box 166 is generally coupled to a first shaft 176 to which a first shaft sprocket 178 is attached. Mounted to an end of the first shaft 176 is an adjustable torque limiter 180. Adjustable torque limiter 180 works to protect the operator 132 for example, by slipping if the brake motor 170 is putting out to much torque or if a back force is applied that could cause damage to the brake motor 170. Adjustable torque limiter 180 prevents any undue torque from reaching the door 102 or the gear box 166. Intermediate shaft assembly 168 generally comprises an intermediate shaft 182, pair of bearings 184a, 184b, an intermediate shaft sprocket 186, an operator sprocket 188 and an encoder 190. Intermediate shaft 182 and first shaft 176 are operably engaged with a first chain 192 that is placed over and engages with the first shaft sprocket 178 and the intermediate shaft sprocket 186. Intermediate shaft 182 can extend through the housing cover 160 whereby a second chain 194 can operably couple the operator sprocket 188 with a torsion shaft sprocket 196.

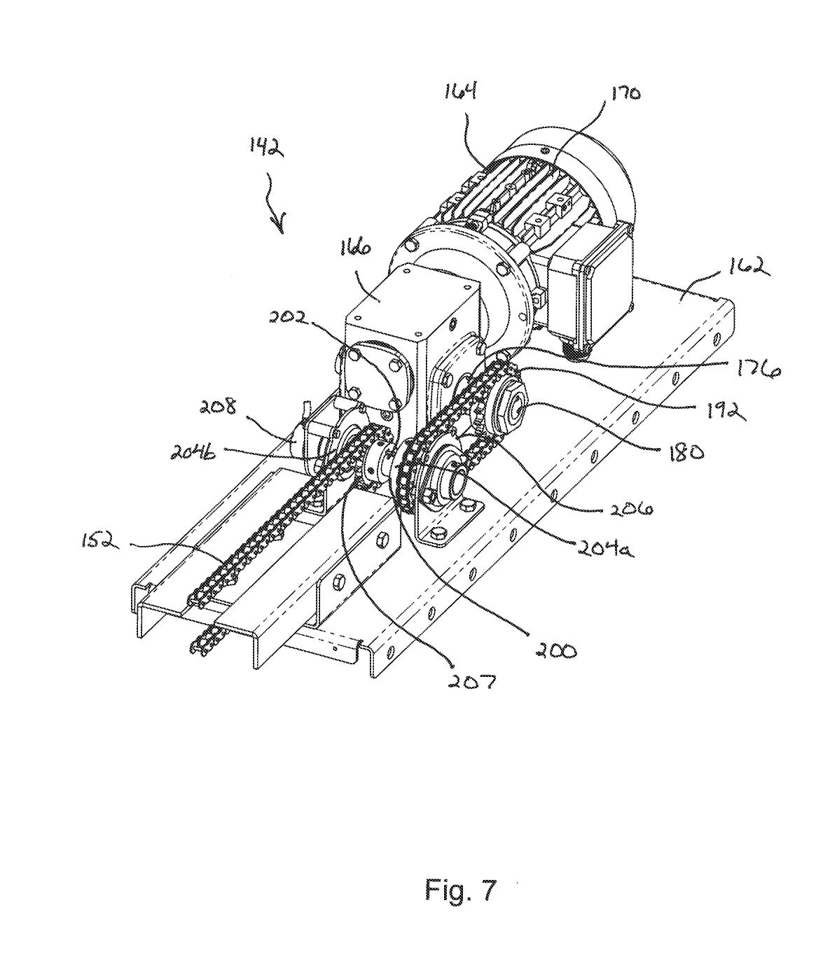

As illustrated in FIG. 7, high speed operator 142 can resemble the high speed operator 132 but with changes to the intermediate shaft assembly 168 and the removal of the second chain 194 and torsion sprocket 196. Instead, high speed operator 142 includes an intermediate shaft assembly 200 wherein an intermediate shaft 202 is fully contained within the housing cover 160. Intermediate shaft assembly 200 includes intermediate shaft 202, a pair of bearings 204a, 204b, an intermediate shaft sprocket 206, a trolley shaft sprocket 207 and an encoder 208. Chain drive 152 is coupled to the trolley shaft sprocket 207 so as to selectively move the movable trolley member 146 forward and back.

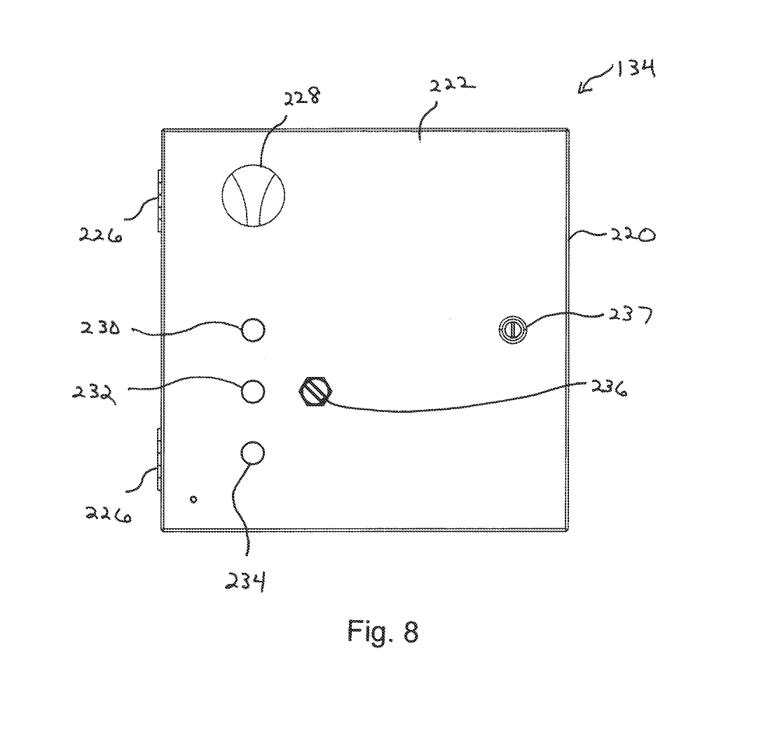

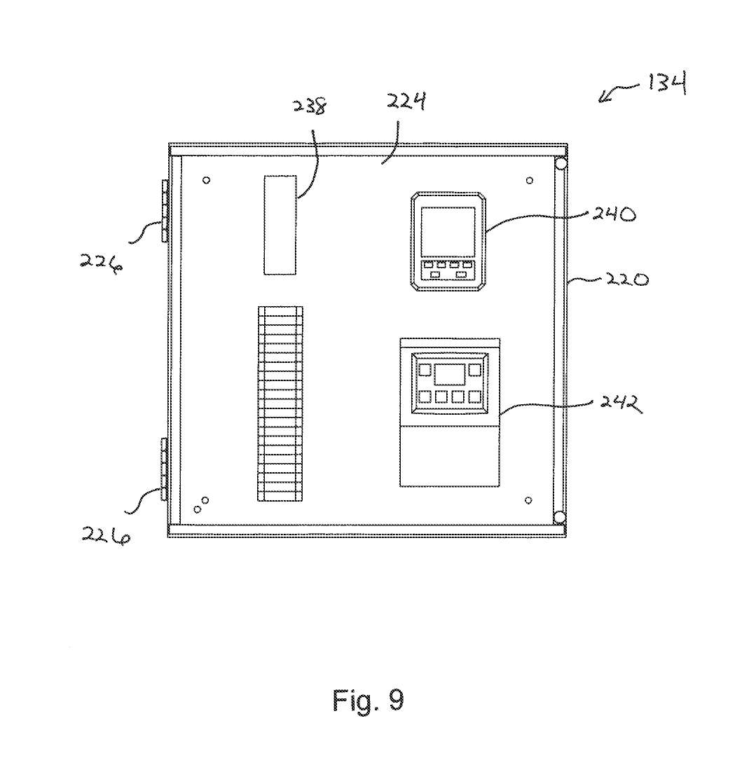

Referring to FIGS. 8 and 9, control panel 134 is capable of being utilized with both high speed operator 132 and high speed operator 142. Control panel 134 generally comprises an enclosure 220 having a front door 222 and an internal mounting panel 224. Front door 222 is preferably attached to the enclosure 220 with a hinge assembly 226. In some embodiments, front door 222 can include an electrical disconnect 228, a door open button 230, a door close button 232, a door stop button 234 and a mode selector switch 236 and a lock assembly 237. Internal mounting panel 224 can include a power supply 238, a system controller 240 and a Variable Frequency Drive (VFD) controller 242. System controller 240 preferably comprises a Programmable Logic Controller (PLC) such as, for example, those available from commercial suppliers such as Allen Bradley, Siemens and the like. Alternatively, system controller 240 can include controllers utilizing computer processors. Single phase power is generally run into the control panel and supplies the power supply 238 and VFD controller 242 with the power supply 238 supplying 24 volt power to the system controller 240 and the VFD controller 242 and the VFD controller 242 outputting three phase power to the brake motor 170. Though not physically mounted within the control panel 134, sensors mounted alongside door tracks 108a, 108b including a proximity sensor 244 and a pair of photoeyes 246a, 246b as seen in FIGS. 1, 2, 5 and 6 are wired to provide input signals to the system controller 240. Though not illustrated, it will be understood that an over travel sensor, for example, a photoeye or limit switch and the like, can also be positioned in an upper location with respect to door tracks 108a, 108b to provide a hardwired input to the system controller 240 to prevent an over travel situation when door 102 is opened.

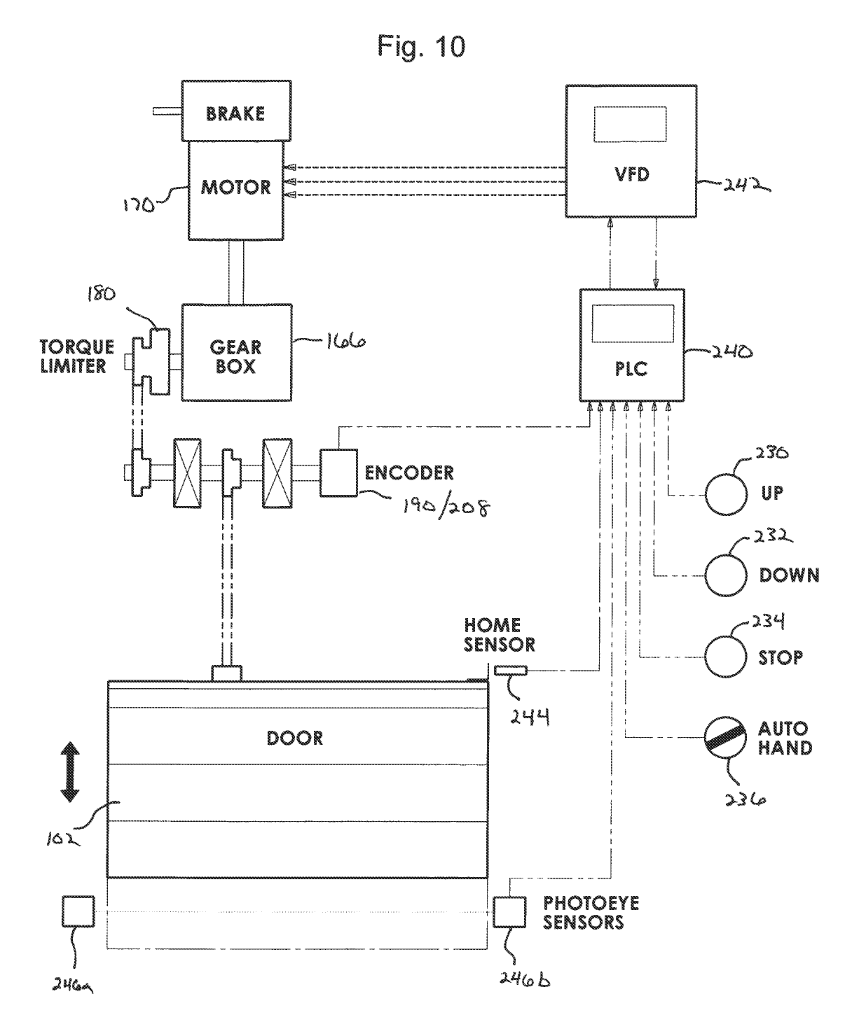

In operation, control panel 134 essentially controls either of high speed operator 132 or high speed operator 142 in a similar manner as illustrated schematically in FIG. 10. Generally, electrical power for the entire system is supplied by connecting single phase power to the power supply 238 which can be terminated via the electrical disconnect 228. Mode selector switch 236 determines whether they system will run in either a manual mode requiring a direct operator input or via an automatic mode in which door 102 is lifted or lowered based upon a control input such as, for example, a pressure switch, a proximity switch, a motion detector, a loop detector, an audio switch and the like, that indicates a vehicle is approaching the door 102. When mode selector switch 236 is positioned in a hand mode, direct use input is required to lift the door 102 by pressing door open button 230, to lower the door 102 by pressing door close button 232 or to immediately stop movement of the door 102 in either a lifting or lowering direction by pressing the door stop button 234. Depending upon the mode of operation, either a control input or inputs from the door open button 230, door close button 232 or door stop button 234, direct the system controller 240 to selectively request the VFD controller 242 supply appropriate three phase power to the brake motor 170 such that brake motor 170 rotates in the desired direction for lifting or lowering the door 102. Depending upon the signal given to the VFD controller 242, internal software and controls will vary the three phase signal to selectively power the brake motor 170 in either a clockwise or counterclockwise direction.

In the case of high speed operator 132, brake motor 170 turns either clockwise or counterclockwise based upon the power input from VFC controller 242. As brake motor 170 turns, first shaft 176 is caused to spin due to its connection with the gear box 166, which is directly attached to a motor shaft of the brake motor 170. As first shaft 176 spins, first shaft sprocket 178 is spun as well causing the first chain 192 to spin the intermediate shaft sprocket 186, and consequently the intermediate shaft 182 turns as well. As intermediate shaft 182 spins, the operator sprocket 188 is also turned such that second chain 194 causes the torsion shaft sprocket 196 to spin, whereby the torsion shaft 118 is turned and the door 102 is caused to be lifted or lowered.

High speed operator 142 operates in a similar manner as described with respect to high speed operator 132 with the exception that as intermediate shaft 202 is caused to rotate, intermediate shaft sprocket 206 causes chain drive 152 to move such that movable trolley member 146 is directed forward and back resulting in door 102 being selectively lifted or lowered.

Utilizing control panel 134 with either of high speed operator 132 or high speed operator 142, advantages are imparted to the opening and closing of door 102 that are generally associated only with high speed roll-up doors. Generally, the design of the present invention allows for an opening and closing speed of the door 102 to exceed at least about 2 feet per second, more preferably at least 2.8 feet per second and most preferably at least 4.0 feet per second. Control panel 134 allows for door 102 to lifted and lowered quickly while providing a variety of safety and control features that prevent damage to the system, vehicles or bystanders.

Generally, VFD controller 242 creates a synthetic sinusoidal voltage from commonly available single phase sources where three synchronized phases can be created and varied from 2 Hz or less to as to achieve high starting torques as shown below.

The frequency of the synthetic three phase signal can be adjusted into overdrive at 150%-200% allowing otherwise fixed speed AC motors to be driven at up to twice their normal rpm. In addition, VFD controller 242 is extremely efficient in its use of power control such that brake motor 170 operating at ⅔ speed will utilize only 25% of the energy required to operate brake motor 170 at full speed without the brake motor 170. Operation of VFD controller 242 is schematically illustrated as follows.

Brake motor 170 can comprise a three-phase induction motor having a starting torque as high as 300% of rated torque. Speed control for brake motor 170 is directly proportional to frequency. As VFD controller 242 is capable tight frequency control, brake motor 170 is capable of being operated at precise speeds.

In order to rapidly open and close the door 102, system controller 240 generally provides a series of command signals to the VFD controller 242 that initiates an opening or closing event. Generally, the system controller 240 directs the VFD controller 242 to execute a PID acceleration curve that causes brake motor 170 to move from a dead stop to full speed within the desired torque limits. As the door 102 approaches a stop point, either closed or open, the system controller 240 commands the VFD controller 242 to decelerate the motor 170 for example, by ramping the VFD output downward along an S-curve, by providing a fractional amount of the prior output, for example, ¼ of the output or by initiating a dynamic braking stop.

Safe operation during rapid opening and closing of the door 102 requires system controller 240 to be constantly provided information concerning door position, speed and direction. Encoders 190 and 208 constantly provide this information to the system controller 240. Encoder 208 can comprise a rotary quadrature encoder that provides digital information to system controller 240 in the form of pulses per rotation using two pulse trains that are 90 degrees out of phase as shown below.

As intermediate shaft 202 rotates, comparison of the two pulse trains, A & B, by system controller 240 yields both the rotation direction and rotary position. Pulse Train A and Pulse Train B are independently supplied to the system controller 240 as high speed inputs wherein the system controller 240 can determine if the pulses are incremented or decremented. Using proximity sensor 244, the data of encoders 190, 208 can be zeroed and restarted each time the door 102 returns to a home position, such as, for example, a closed position. Any errors that develop during a single open/close cycle are deleted and the data can be completely reset during each cycle. By mounting the encoders 190, 208 on their corresponding intermediate shaft 182, 202, encoders 190, 208 remain fixedly coupled to the door 102 and maintain a fixed rotary relationship with the door 102 even in the event of slippage of the torque limiter 180 that could disrupt the rotational relationship of the door 102 and motor 170/gear box 166. Alternatively encoders 190, 208 can comprise analog encoders that have the advantage of maintaining the home position following loss of power while a digital encoder will generally require a reset to the home position following power loss.

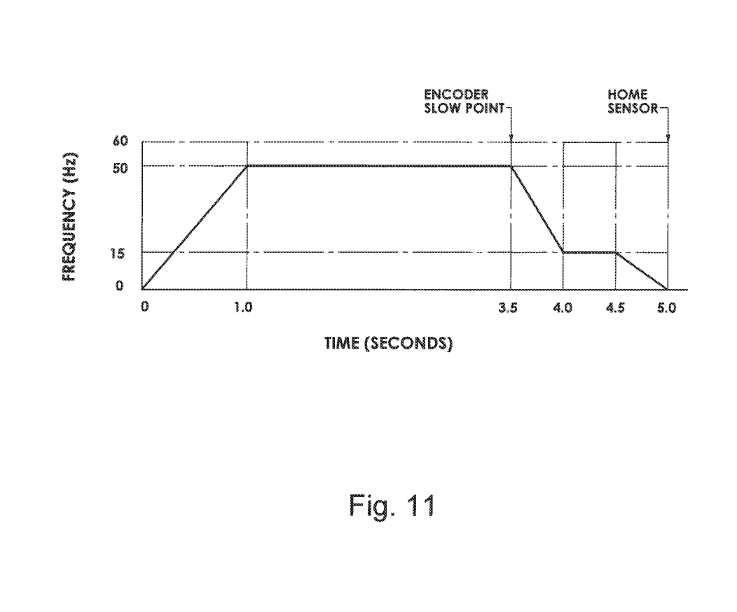

Referring now to FIG. 11, a Frequency Timing Diagram illustrates a frequency profile for VFD controller 242 during an automated open/close event. Initially, door 102 is accelerated linearly using an acceleration curve as dictated by the VFD controller 242. Once door 102 has been fully accelerated to a desired operation speed, door 102 remains at this speed until the door 102 approaches a slow-down setpoint. The slow-down setpoint is determined and programmed into the system controller 240 during initial installation and set-up of the garage door assembly 100 and is determined by operation of the encoder 208. When the encoder 208 reports that the slow down setpoint has been reached, VFD controller 242 reduces the output frequency to motor 170 such that the door quickly decelerates. The rate at which VFD controller 242 ramps down the motor 170 can be uniquely tailored to each individual installation and will vary based upon door load and other factors. In some installation, the output of VFD controller 242 can decelerate motor 170 in an S-curve fashion or simply reduced the motor 170 to roughly ¼ speed. The door 102 travels at the reduced speed until the proximity sensor 244 signals the presence of the door 102 and the output from VFD controller 242 to motor 170 is terminated and door 102 essentially coasts to a stop.

Acceleration, deceleration and operational speed can be unique tailored for each installation based upon factors such as door weight, length of travel, customer desired cycle times and operational safety. Using the assumptions as detailed below, it can be seen that garage door assembly 100 allows door 102 to be raised over 14 feet in as little as 5 seconds. During operation, the maximum speed of the door 102 during lifting and closing can be as high as 4 feet per second.

### Installation Assumptions For Raising Panel Door Over 14 Feet In 5 Seconds

| Cable Drum Diameter | 4 | inches |
|---|---|---|
| Circumference | 12.57 | inches |
| GearBox Reduction | 5:1 | |
| | 0.2 | |
| Sprocket, Gearbox | 19 | |
| Sprocket, Encoder | 19 | |
| Chain Ratio | 1.00 | |
| Sprocket, Intermediate | 19 | |
| Shaft | | |
| Sprocket, Jackshaft | 14 | |
| Chain Ratio | 0.74 | |
| Motor Speed | 1800 | |
| Frequency | 50 | |
| Incoming Frequency | 60 | |
| % Speed | 0.833 | |
| Output Shaft RPM | 221 | RPM |
| Output Shaft RPS | 3.68 | RPS |
| Normal Door Speed | 46 | IPS |
| Normal Door Speed | 3.9 | FPS |

Although specific examples have been illustrated and described herein and within the attached Appendix A, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

1. A high speed garage door system, comprising:
a garage door having a plurality of door wheels on opposed door sides;
a pair of door tracks into which the plurality of door wheels are mounted;
a torsion shaft mounted between the door tracks, the torsion shaft including at least one counterbalancing spring and a pair of cable drum, each cable drum including a wound cable operably coupled to the insulated garage door;
a high speed operator operably coupled to the torsion shaft, the high speed operator including a motor and an encoder; and
a control panel electrically connect to the high speed operator, the control panel including a controller and a variable frequency drive, wherein the controller directs the variable frequency drive to accelerate the motor from a dead stop status to a full speed status within a torque limit and wherein the controller directs the variable frequency drive to decelerate the motor, wherein the encoder supplies positioning information of the insulated garage door to the controller during acceleration and deceleration of the motor.

2. The high speed garage door system of claim 1, wherein the high speed operator is directly coupled to the garage door.

3. The high speed garage door system of claim 1, wherein the high speed operator is directly coupled to the torsion shaft.

4. The high speed garage door system of claim 1, wherein the high speed operator including an adjustable torque limiter, and wherein the torque limit is set by the adjustable torque limiter.

5. The high speed garage door system of claim 1, wherein the control panel further comprises a mode selector switch, said mode selector switch determining whether the controller operates off a manual input or an automatic input.

6. The high speed garage door system of claim 5, wherein the manual input comprises a door open button, a door close button and a door stop button.

7. The high speed garage door system of claim 5, wherein the automatic input is selected from the group consisting essentially of: a pressure switch, a proximity switch, a motion detector, a loop detector and an audio switch.

8. The high speed garage door system of claim 1, wherein full speed status is at least 2 feet per second.

9. The high speed garage door system of claim 1, wherein the control panel includes a proximity sensor mounted alongside one of the door tracks, the proximity sensor defining a home position for the insulated garage door such that the controller resets the encoder each time the insulated garage door returns to the home position.

10. The high speed garage door of claim 1, wherein a slow-down setpoint for the insulated garage door is programmed into the controller and the position of the insulated garage door along the door tracks is determined by the encoder, such that when the encoder determines the insulated garage door has reached the slow-down setpoint, the controller initiates deceleration of the motor.

11. A method for opening and closing of garage doors having counter balancing springs, comprising:
providing a first signal to a controller, wherein the controller directs a variable frequency drive to initiate operation of a motor;
accelerating the motor from a dead stop status to a full speed status within a specified torque limit, wherein the motor is operably connected to a garage door;
monitoring a door position of the insulated garage door using an encoder that monitors a rotational output of the motor; and
decelerating the motor with a dynamic braking stop based on the door position reaching a slow-down setpoint as determined by the encoder.

12. The method of claim 11, further comprising:
setting the specified torque limit by adjusting a torque limiter positioned on an output shaft of the motor.

13. The method of claim 11, wherein the full speed status is at least 2 feet per second.

14. The method of claim 11, wherein operably connecting the motor to the insulated garage door, further comprises:
providing a moving trolley member that is operably interconnected to the motor; and
coupling the moving trolley member to the insulated garage door.

15. The method of claim 11, wherein operably connecting the motor to the insulated garage door, further comprises:
providing a chain that is operably interconnected to the motor; and
coupling the chain to a torsion shaft having a torsion spring cable, wherein the torsion spring cable is attached to the insulated garage door.

16. The method of claim 11, further comprising:
establishing a home position for the garage door by positioning a proximity sensor alongside a door track in which the insulated garage door is mounted; and
resetting the encoder with the controller each time the insulated garage door is in the home position.

17. The method of claim 16, further comprising:
providing a second signal from the controller to the variable frequency drive directing the variable frequency drive to cease operation of the motor when the insulated garage door is in the home position.

18. The method of claim 11, wherein the step of providing the first signal to the controller, further comprises:
providing the first signal selected from the group comprising: a door open signal, a door close signal and a door stop signal.

19. The method of claim 18, wherein the signal is a manual signal.

20. The method of claim 18, wherein the signal is an automatic signal.
